(19) United States
(12) Patent Application Publication
(10) Pub. No.: US 2021/0287188 A1
(43) Pub. Date: Sep. 16, 2021

(54) SYSTEMS AND METHODS FOR MANAGING MERCHANT-STORED PAYMENT CREDENTIALS

(71) Applicant: JPMORGAN CHASE BANK, N.A., New York, NY (US)

(72) Inventors: Navneet KANG, Garnet Valley, PA (US); Jeffrey D. LANGUS, Mamaroneck, NY (US); Janice Yoke Leng WONG, New York, NY (US)

(21) Appl. No.: 16/820,203

(22) Filed: Mar. 16, 2020

(51) Int. Cl. G06Q 20/10; G06Q 20/40; G06Q 20/36

(52) U.S. Cl. CPC G06Q 20/102; G06Q 20/3672; G06Q 20/4018; G06Q 20/4093

(57) ABSTRACT

Systems and methods for managing merchant-stored payment credentials are disclosed. In one embodiment, in a financial institution backend comprising at least one computer processor, a method for managing merchant-stored payment credentials may include: (1) receiving, from a customer and in a first user interface, a selection of a merchant that is eligible for financial instrument pushing; (2) opening a second user interface with the selected merchant, wherein the login credentials for the merchant are received from the customer in the second user interface; (3) receiving, from the customer and in the first user interface, a selection of a financial instrument to push; and (4) providing, to an aggregator, financial instrument data for the selected financial instrument. The aggregator pushes the financial instrument data to the merchant.

### FIELD OF THE INVENTION

The present disclosure generally relates to systems and methods for managing merchant-stored payment credentials.

### DESCRIPTION OF THE RELATED ART

It is commonplace for a customer to save a payment instrument, such as a credit or debit card, with a merchant for recurring payment. For example, customers save cards with online merchants, online subscription services, etc. to avoid having to enter card data for every transaction. If a card is reported as lost or stolen and the customer has a new card number issued, the customer has to go back through past statements to determine which merchants need to have payment information updated.

### SUMMARY OF THE INVENTION

Systems and methods for managing merchant-stored payment credentials are disclosed. In one embodiment, in a financial institution backend comprising at least one computer processor, a method for managing merchant-stored payment credentials may include: (1) receiving, from a customer and in a first user interface, a selection of a merchant that is eligible for financial instrument pushing; (2) opening a second user interface with the selected merchant, wherein the login credentials for the merchant are received from the customer in the second user interface; (3) receiving, from the customer and in the first user interface, a selection of a financial instrument to push; and (4) providing, to an aggregator, financial instrument data for the selected financial instrument. The aggregator pushes the financial instrument data to the merchant.

In one embodiment, the method may further include: reviewing customer transaction data with a plurality of merchants; and identifying the merchant from the customer transaction data based on a plurality of transactions with the merchant.

In one embodiment, the financial instrument data may include at least one of a customer name, a financial instrument number, an expiration date, a CVV, a billing zip code, etc.

In one embodiment, the method may further include requesting a session identifier for the customer from the aggregator. The session identifier is provided to the aggregator with the financial instrument data for the selected financial instrument. The session identifier may include a token having an expiration.

In one embodiment, the second user interface may include a lightbox.

According to another embodiment, in a financial institution backend comprising at least one computer processor, and in response to an event in which a financial instrument number issued to a customer changes, a method for managing merchant-stored payment credentials may include: (1) identifying at least one merchant to which the financial instrument has been pushed by an aggregator; (2) receiving, from the customer, approval to provide replacement financial instrument data to the aggregator; and (3) providing the replacement financial instrument data to the aggregator, wherein the aggregator pushes the replacement financial instrument data to the at least one merchant.

In one embodiment, the financial institution backend may request the financial instrument that has been pushed by the aggregator from the aggregator.

In one embodiment, the method may further include receiving approval from the customer to provide the replacement financial instrument data to the aggregator.

In one embodiment, the financial instrument may be reported as lost or stolen.

In one embodiment, the request for the identification of at least one merchant to which the financial instrument has been pushed may include a customer identifier.

According to another embodiment, in a financial institution backend comprising at least one computer processor, a method for cancelling payment using a pushed payment instrument may include: (1) retrieving, from a first aggregator, an identification of at least one merchant to which a financial institution issued to a customer has been pushed; (2) presenting, to the customer, the identification of the at least one merchant; (3) receiving, from the customer, request to cancel a recurring payment with at least one of the merchants; and (4) communicating, to a second aggregator, financial information for the financial instrument with a request to cancel the recurring payment. The second aggregator may cancel the recurring payment with the merchant.

In one embodiment, the method may further include determining, based on customer transaction data with the merchant, that the recurring payments were conducted with the merchant. The determination may be based on a transaction flag in a plurality of transactions with the merchant, a timing of a plurality of transactions with the merchant, etc.

In one embodiment, the first aggregator and the second aggregator may be the same.

In one embodiment, the method may further include receiving, from the customer, customer account information to identify a customer account with the merchant for the recurring payment. The customer account information may be provided to the second aggregator with the request to cancel.

In one embodiment, the merchant account information may include a customer email address associated with the customer account.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for managing merchant-stored payment credentials according to one embodiment;

FIG. 2 depicts a method for managing merchant-stored payment credentials according to one embodiment;

FIG. 3 depicts a method for managing merchant-stored payment credentials is provided according to another embodiment; and

FIG. 4 depicts a method for managing merchant-stored payment credentials is provided according to yet another embodiment.

### DETAILED DESCRIPTION OF PREFERRED EMBODIMENTS

Embodiments are generally directed to systems and methods for managing merchant-stored payment credentials.

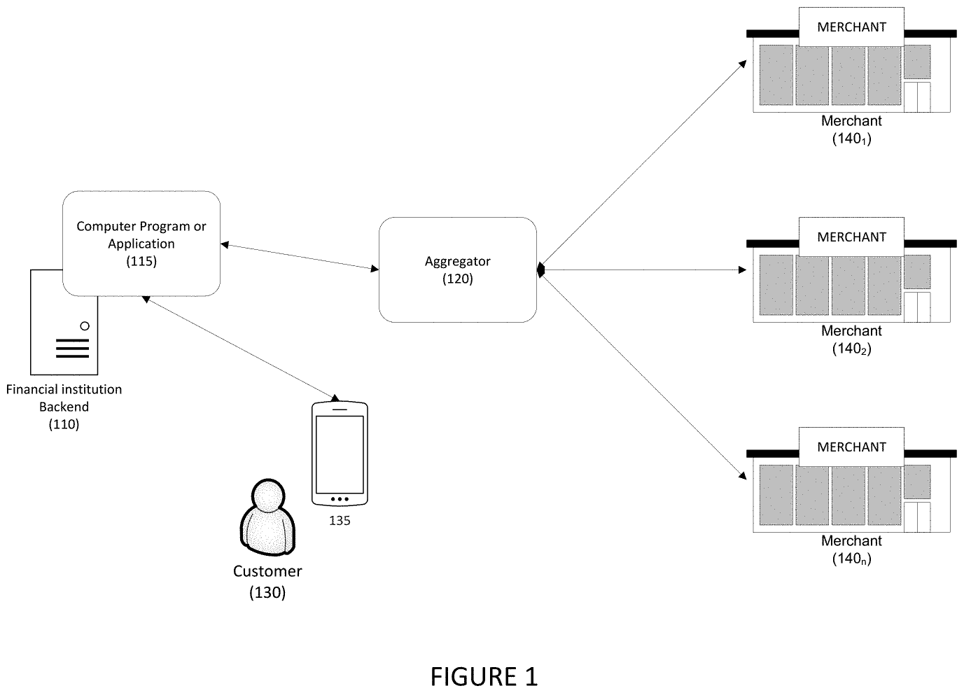

Referring to FIG. 1, a system for managing merchant-stored payment credentials is disclosed. System 100 may include financial institution backend 110 that may execute computer program or application 115 for managing merchant-stored payment credentials. Financial institution backend 110 may include any suitable electronic device, including servers (physical and/or cloud-based), computers, etc.

System 100 may further include aggregator 120 which may have a relationship with one or more merchant 140. For example, each merchant 140 may be registered with aggregator 120, and may have a public-private key relationship.

In one embodiment, aggregator 120 may abstract different API contracts that it has for one or more merchant 140. It may provide a uniform experience for customer 130.

Merchants 140 may be any suitable type of merchant, including on-line, physical, etc. with which customer 130 may maintain an account. In one embodiment, merchant 140 may repeatedly (e.g., periodically, on demand, etc.) provide a good or service to customer 130 for which the customer may wish to avoid entering payment information for. Examples may include retailers, entertainment providers (e.g., streaming services, music subscription services), Internet service providers, cell phone providers, utility providers, restaurants, health care providers, etc. Any suitable merchant 140 may be included as is necessary and/or desired.

Customer 130 may be a customer of the financial instrument associated with financial institution backend 110 and/or computer program or application 115. In one embodiment, customer 130 may access financial institution backend 110 using one or more electronic device 135, including smartphones, computers (e.g., desktop, laptop, notebook, etc.), Internet of Thing (“IoT”) appliances, terminals, kiosks, etc. For example, customer 130 may access financial institution backend 110 and/or computer program or application 115 using a browser, an application or program, etc.

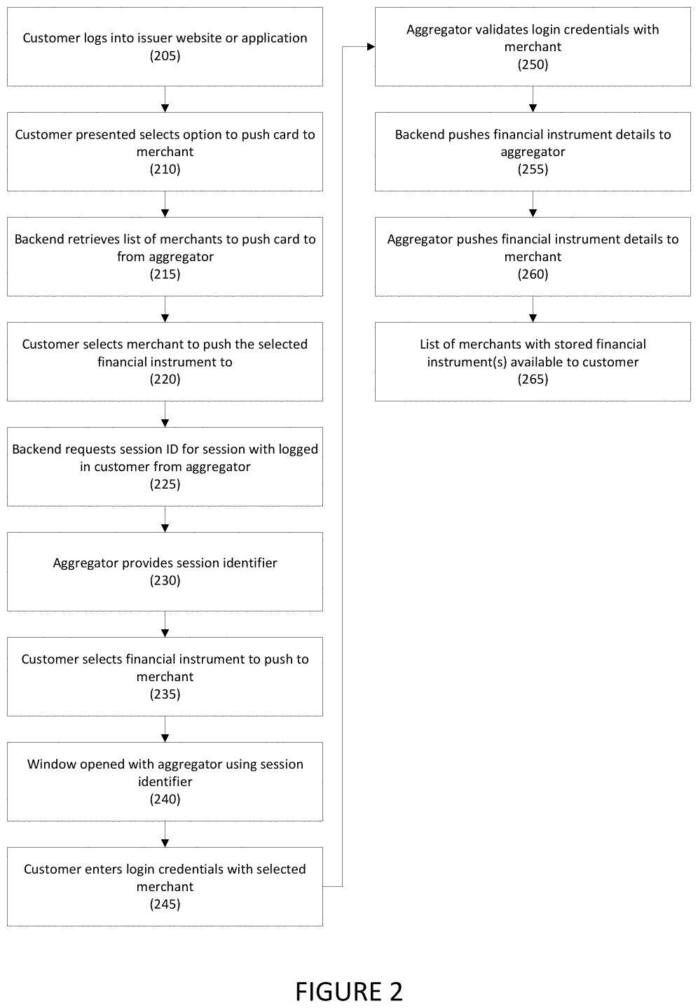

Referring to FIG. 2, a method for managing merchant-stored payment credentials is provided according to one embodiment.

In step 205, a customer of a financial institution may log into the financial institution's website or application.

In step 210, the customer may be presented with an option to push a card to a merchant for recurring payments. In one embodiment, the merchant may include any entity with which the customer may have, or may expect to have, recurring payments, with.

In step 215, the financial institution backend may provide the customer with a list of merchants to which the customer may push a financial instrument. For example, the backend may present the most popular merchants, may present merchant categories and the customer may explore each category to find the desired merchant, may make recommendations based on transaction history, etc.

In one embodiment, the customer may be provided with a list of repeating and non-repeating transactions where the customer's payment instrument (e.g., a credit card) was not physically present. For example, if the customer makes non-repeating payments to an online retailer, and has not yet pushed a credit card to the online retailer, the online retailer may be identified to the customer.

In one embodiment, merchants to which the customer has pushed the payment instrument to may be included as is necessary and/or desired.

In one embodiment, the backend may retrieve a list of available merchants from an aggregator, and may present only merchants with which the aggregator has a relationship may be selected.

In step 220, the customer may select the merchant to push the selected financial instrument to, and in step 225, the financial institution backend may request a session identifier for the active customer session with an aggregator from the aggregator. This implies that the customer is logged in to the financial institution and has been validated.

In one embodiment, the aggregator may create an alias to the financial institution customer id/identifier on the aggregator side (e.g., on the first access) to track the financial instruments that have been pushed to merchants and their statuses (e.g., success or failed). In one embodiment, the session identifier may be created each time the financial institution has validated the customer and wants to allow the customer to push or update card on merchant via the aggregator.

In one embodiment, the aggregator may have relationships with a plurality of merchants.

In step 230, the aggregator may return the session identifier to the financial institution backend. In one embodiment, the session identifier may comprise a token. In one embodiment, the token may have an expiration in order to increase security. For example, the token may expire after 15 minutes.

In one embodiment, the aggregator may generate a customer identifier for the customer, and may store an association between the customer identifier and the customer.

In step 235, the customer may select a financial instrument to push to a merchant. In one embodiment, the customer may be presented with a list of available financial instruments that may be pushed. In another embodiment, the customer may select a financial instrument from a wallet. Any suitable manner of identifying a financial instrument may be used as is necessary and/or desired.

In step 240, a window, such as a lightbox, may be opened with the selected merchant, and in step 245, the customer may enter login credentials for the selected merchant in the window. In step 250, the aggregator may validate the credentials with the merchant. If the customer's login fails, the process may stop.

In step 255, the financial institution backend may push details for the selected financial instrument to the aggregator. For example, the financial institution backend may provide a cardholder name, a card number, an expiration date, a CVV, a billing zip code, etc. In one embodiment, the session identifier may be provided.

Other information, including shipping information, may be provided as is necessary and/or desired.

In step 260, the aggregator may provide the card to the selected merchant.

In step 265, a list of financial instruments and with the merchants with which each financial instrument has been pushed may be available to the customer.

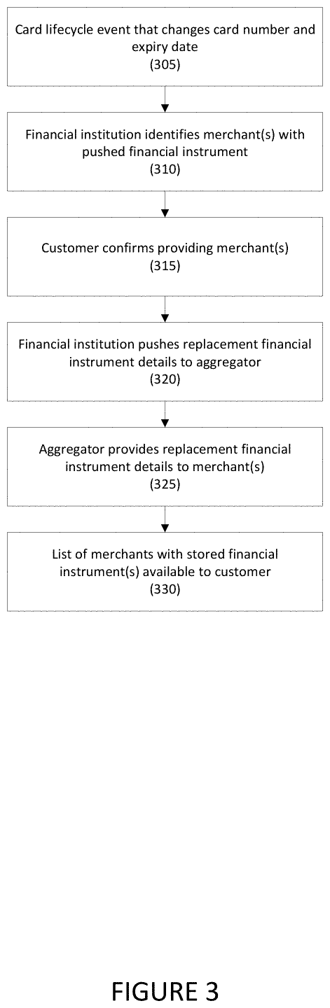

Referring to FIG. 3, a method for managing merchant-stored payment credentials is provided according to another embodiment.

In step 305, a card lifecycle event may occur in which the card number and the card expiry date change. For example, the card may be reported as lost or stolen by the customer.

In step 310, the financial institution backend may identify merchant(s) to which the financial instrument has been pushed. In one embodiment, the financial institution backend may retrieve this information from its records. In another embodiment, the financial institution may request this information from an aggregator, and the aggregator may return the merchant(s) to the financial institution backend to which the financial instrument has been pushed.

In step 315, the customer may be provided with the merchant(s) to which the financial instrument has been pushed and may authorize the financial institution backend to push the replacement financial instrument details to the merchant(s). For example, the financial institution backend may send a message to the customer (e.g., SMS message, email, in-application message, etc.) for the customer to approve the push. In one embodiment, the customer may not be required to log-in or otherwise authenticate to the financial institution to approve the push.

In step 320, the financial institution may provide replacement financial instrument details to the aggregator.

In step 325, the aggregator may provide the replacement financial instrument details to the merchant(s) identified in step 310. This may be similar to step 260.

In step 330, a list of financial instruments and with the merchants with which each financial instrument has been pushed may be available to the customer.

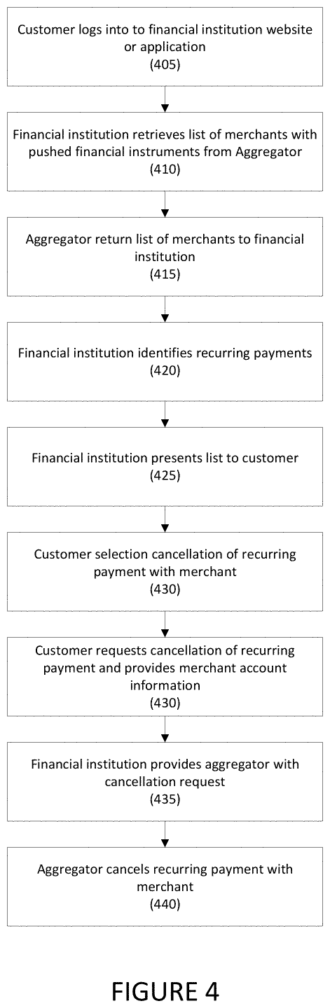

Referring to FIG. 4, a method for cancelling recurring payment using a pushed payment instrument is provided according to one embodiment. For example, a customer may have pushed a card to a merchant for recurring payments, and may later decide to cancel the recurring payments.

In step 405, a customer of a financial institution may log into the financial institution's website or application.

In one embodiment, the customer may select an option to cancel merchant-stored financial instruments.

In step 410, the financial institution backend may retrieve merchants to which the financial instrument has been pushed from an aggregator. In one embodiment, the financial institution backend may provide the aggregator with a customer identifier.

In step 415, the aggregator may return the list of merchants to the financial institution backend.

In step 420, the financial institution backend may identify whether the merchant(s) have recurring payments, indicating a subscription, or payments for customer-directed transactions. In one embodiment, the financial institution backend may review transactions for a flag (e.g., a card not present indicator), the amount of the transaction (e.g., the same amount), the timing of the payments (e.g., the same day each month), whether a CVV was entered, transactions other customers may have with the merchant, etc., in order to determine whether the transactions are recurring transactions.

In one embodiment, machine learning may be used to determine whether the transactions are recurring or not.

In step 425, the customer may be presented with the list of merchant-stored financial instrument(s) and the merchant(s) with which the financial instrument(s) are stored. In one embodiment, the customer may be presented with an indication as to whether the customer has recurring payments with each merchant.

In one embodiment, the financial institution backend may provide additional information, such as whether there are any out-of-pattern transaction (e.g., a transaction that does not fit the customer's normal spending pattern), unexpected transactions (e.g., a transaction with a merchant with which there has not been a transaction for some time), etc.

In step 430, the customer may request cancellation of a recurring payment with a merchant. In one embodiment, the customer may be required to provide certain information in order to process the cancellation. For example, the customer may be required to enter one or more of the customer's date of birth, billing zip code, last four digits of the financial instrument account number, email address used for the subscription, etc.

In one embodiment, the information required may depend on the merchant.

In step 435, the financial institution backend may communicate the request to the aggregator. In one embodiment, the financial institution backend may communicate the credit card number and the account identifying information to the merchant.

In step 440, the aggregator may cancel the recurring payment with the merchant. In one embodiment, the merchant may confirm cancellation.

It should be recognized that although several different embodiments are disclosed, these embodiments are not exclusive. Thus, although certain features may be disclosed in the context of one embodiment, the features may be used any embodiment as is necessary and/or desired.

Hereinafter, general aspects of implementation of the systems and methods of the embodiments will be described.

The system of the embodiments or portions of the system of the embodiments may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the embodiments.

The processing machine used to implement the embodiments may utilize a suitable operating system. Thus, embodiments may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the methods as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the embodiments. Rather, any number of different programming languages may be utilized as is necessary and/or desirable.

Also, the instructions and/or data used in the practice of the embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the embodiments.

Further, the memory or memories used in the processing machine that implements the embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the embodiments, a variety of “user interfaces” may be utilized to allow a user to interface with the processing machine or machines that are used to implement the embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method of the embodiments may interact partially with another processing machine or processing machines, while also interacting partially with a human user.

It will be readily understood by those persons skilled in the art that the present embodiments are susceptible to broad utility and application. Many embodiments and adaptations other than those herein described, as well as many variations, modifications and equivalent arrangements, will be apparent from or reasonably suggested by the present embodiments and foregoing description thereof, without departing from the substance or scope of the invention.

Accordingly, while the present exemplary embodiments have been described here in detail, it is to be understood that this disclosure is only illustrative and exemplary and is made to provide an enabling disclosure of the invention. Accordingly, the foregoing disclosure is not intended to be construed or to limit the present embodiments or otherwise to exclude any other such embodiments, adaptations, variations, modifications or equivalent arrangements.

What is claimed is:

1. A method for managing merchant-stored payment credentials is provided according to one embodiment.
in a financial institution backend comprising at least one computer processor:
receiving, from a customer and in a first user interface, a selection of a merchant that is eligible for financial instrument pushing;
opening a second user interface with the selected merchant, wherein the login credentials for the merchant are received from the customer in the second user interface;
receiving, from the customer and in the first user interface, a selection of a financial instrument to push; and
providing, to an aggregator, financial instrument data for the selected financial instrument;
wherein the aggregator pushes the financial instrument data to the merchant.

2. The method of claim 1, further comprising:
reviewing customer transaction data with a plurality of merchants; and
identifying the merchant from the customer transaction data based on a plurality of transactions with the merchant.

3. The method of claim 1, wherein the financial instrument data comprises at least one of a customer name, a financial instrument number, and an expiration date.

4. The method of claim 4, wherein the financial instrument data further comprises a CVV and a billing zip code.

5. The method of claim 5, further comprising:
requesting a session identifier for the customer from the aggregator;
wherein the session identifier is provided to the aggregator with the financial instrument data for the selected financial instrument.

6. The method of claim 5, wherein the session identifier comprises a token having an expiration.

7. The method of claim 1, wherein the second user interface comprises a lightbox.

8. A method for managing merchant-stored payment credentials, comprising:
in a financial institution backend comprising at least one computer processor, and in response to an event in which a financial instrument number issued to a customer changes:
identifying at least one merchant to which the financial instrument has been pushed by an aggregator;
receiving, from the customer, approval to provide replacement financial instrument data to the aggregator; and
providing the replacement financial instrument data to the aggregator;
wherein the aggregator pushes the replacement financial instrument data to the at least one merchant.

9. The method of claim 8, wherein the financial institution backend requests the financial instrument that has been pushed by the aggregator from the aggregator.

10. The method of claim 8, wherein the financial instrument is reported as lost or stolen.

11. The method of claim 8, wherein the request for the identification of at least one merchant to which the financial instrument has been pushed comprises a customer identifier.

12. A method for cancelling payment using a pushed payment instrument, comprising:
in a financial institution backend comprising at least one computer processor:
retrieving, from a first aggregator, an identification of at least one merchant to which a financial institution issued to a customer has been pushed;
presenting, to the customer, the identification of the at least one merchant;
receiving, from the customer, request to cancel a recurring payment with at least one of the merchants; and
communicating, to a second aggregator, financial information for the financial instrument with a request to cancel the recurring payment;
wherein the second aggregator cancels the recurring payment with the merchant.

13. The method of claim 12, further comprising:
determining, based on customer transaction data with the merchant, that the recurring payments were conducted with the merchant.

14. The method of claim 13, wherein the determination is based on a transaction flag in a plurality of transactions with the merchant.

15. The method of claim 13, wherein the determination is based on a timing of a plurality of transactions with the merchant.

16. The method of claim 12, wherein the first aggregator and the second aggregator are the same.

17. The method of claim 12, further comprising:
receiving, from the customer, customer account information to identify a customer account with the merchant for the recurring payment;
wherein the customer account information is provided to the second aggregator with the request to cancel.

18. The method of claim 17, wherein the merchant account information comprises a customer email address associated with the customer account.
